(19) United States
(12) Patent Application Publication
(10) Pub. No.: US 2021/0103811 A1
(43) Pub. Date: Apr. 8, 2021

(54) APPARATUS AND METHOD FOR SUGGESTING ACTION ITEM BASED ON SPEECH

(71) Applicant: LG ELECTRONICS INC., Seoul (KR)

(72) Inventor: Tae Hyun KIM, Seoul (KR)

(73) Assignee: LG ELECTRONICS INC., Seoul (KR)

(21) Appl. No.: 16/730,850

(22) Filed: Dec. 30, 2019

(30) Foreign Application Priority Data
Oct. 2, 2019 (KR) 10-2019-0122351

(51) Int. Cl. G06N 3/08; G06N 3/04; G10L 15/22; G10L 15/16

(52) U.S. Cl. CPC G06N 3/08; G06N 3/04; G10L 2015/088; G10L 15/16; G10L 2015/223; G10L 15/22

(57) ABSTRACT

Provided are a method and apparatus for suggesting an action item based on speech. The method for suggesting an action item includes collecting a user's voice, analyzing a user's action item based on the user's voice, and suggesting the action item based on an analysis result of the action item. Based on an analysis using an AI model through a 5G network and an artificial intelligence (AI) acceleration chipset, a voice of an action item by active utterance can be suggested.

### CROSS-REFERENCE TO RELATED APPLICATION

Pursuant to 35 U.S.C. § 119(a), this application claims the benefit of earlier filing date and right of priority to Korean Patent Application No. 10-2019-0122351, filed on Oct. 2, 2019, the contents of which are hereby incorporated by reference herein in its entirety.

### BACKGROUND

### 1. Technical Field

The present disclosure relates to an apparatus and method for suggesting an action item based on speech, and more particularly, to a virtual assistant agent apparatus and a method for suggesting an action item thereof capable of suggesting a user's action item by collecting information from a user's self-talk and allowing the user to first start uttering based on the collected information.

### 2. Description of Related Art

A virtual assistant is a software agent that handles tasks requested by a user like a personal assistant and provides specialized services to the user.

The virtual assistant collects and provides information customized to a user based on an artificial intelligence (AI) engine and speech recognition, and perform various tasks such as scheduling, sending e-mail, and booking a restaurant according to a user's voice command The virtual assistant can be mounted in various smart home appliances or vehicles, and an application range thereof is gradually expanding.

A smart speaker, which is one of the home appliances combined with the virtual assistant, is also called an AI speaker. The AI speaker performs functions such as listening to music and searching for information based on the speech recognition.

According to a recent survey of users of the smart speaker, the users point out unnatural connections between conversations and providing only simple convenience functions in life as the lacks of the smart speaker. The active participation of the smart speaker in the conversation is still limited in that the smart speaker is operated by a user's utterance of a wake-up word.

As one of the related arts, a facial recognition-based intelligent speaker is disclosed in the registration publication of KR Patent No. 10-1933822. According to this related art, conversation sentences about common interest topics among conversers are output as a voice using images obtained by photographing the conversers. However, this related art has a disadvantage in that active utterance independent of the user is impossible in that passive conversation sentences are output based on the user's conversation.

As another related art, an interactive AI agent system is disclosed in the publication of Korean Patent Laid-Open Publication No. 10-2019-0094080. According to this related art, an active order or a reservation service is provided to multiple users based on monitoring a conversation session between multiple users. However, according to this related art, the active utterance of the AI agent is restrictively realized only under certain conditions in that a plurality of conversers has to participate in a conversation and the AI agent does not actively participate in a conversation between users when there is no user's utterance.

### SUMMARY OF THE INVENTION

An aspect of the present disclosure is to solve the problem of the related art that an AI agent can be uttered only when there is a single user's utterance or a conversation between a plurality of users.

Another aspect of the present disclosure is to solve the problem of the related art of an AI agent participating in a conversation with users only by monitoring the conversation between the users.

Still another aspect of the present disclosure is to solve the problem of the related art of an AI agent exhibiting only a passive assistant function.

While this disclosure includes specific embodiments, it will be apparent to one of ordinary skill in the art that various changes in form and details may be made in these embodiments without departing from the spirit and scope of claims and their equivalents. The embodiments described herein are to be considered in a descriptive sense only, and not for purposes of limitation. Further, it is understood that the objects and advantages of the present disclosure may be embodied by the means and a combination thereof in claims.

According to an aspect of the present disclosure, a method for suggesting an action item based on speech may include collecting at least one input data among monitoring data of a device and voice data of a user, analyzing a user's action item based on the at least one input data, and suggesting the action item based on the analysis result of the action item.

The collecting of the input data may include collecting information on uttered self-talk without a wake-up word.

The collecting of the input data may further include activating a microphone using an operation detection to collect the information on the self-talk.

The collecting of the input data may further include monitoring a device operated after the utterance of the self-talk based on the information on the self-talk. The analyzing of the action item may include analyzing an action item related to the operation of the device.

The analyzing of the action item may include classifying the action item using a keyword included in the self-talk among the user's voices and the operation of the device related to the keyword.

The analyzing of the action item may include analyzing a generation pattern of the classified action item.

The analyzing of the action item may include training an action item suggestion model of a deep neural network to classify a user's action item based on deep learning using a training data set including at least one of a user's self-talk, a device operated in relation to the self-talk, and information on an operation mode and an operation time and date of the device when operated.

The suggesting of the action item may include suggesting the action item through the voice using the action item suggestion model.

The suggesting of the action item may include analyzing a generation requirement of the action item using the action item suggestion model, inferring the generation of the action item based on a determination of the generation requirement, and suggesting the inferred action item.

The method for suggesting an action item may further include controlling the operation of the device related to the action item according to the execution of the suggested action item.

According to another aspect of the present disclosure, an apparatus for suggesting an action item based on speech may include a microphone configured to collect a user's voice, an action item suggestion engine configured to analyze a user's action item based on the user's voice and suggesting the action item in advance based on the analysis result of the action item, and a processor configured to control the microphone and the action item suggestion engine.

The processor may control the microphone to collect information on uttered self-talk without a wake-up word.

The processor may activate the microphone using an operation detection to collect the information on the self-talk.

The processor may control the action item suggestion engine to monitor a device operated after the utterance of the self-talk based on the information on the self-talk and analyze an action item related to the operation of the device.

The processor may control the action item suggestion engine to classify the action item using a keyword included in the self-talk among the user's voices and the operation of the device related to the keyword.

The processor may control the action item suggestion engine to analyze a generation pattern of the classified action item.

The action item suggestion engine may include a deep neural network classifying a user's action item based on deep learning. The processor may train an action item suggestion model of the deep neural network using a training data set including at least one of a user's self-talk, a device operated in relation to the self-talk, and information on an operation mode and an operation time and date of the device when operated.

The processor may suggest the action item through the voice using the action item suggestion model.

The processor may analyze a generation requirement of the action item using the action item suggestion model and suggest an action item inferred based on a determination of the generation requirement.

The processor may control the operation of the device related to the action item according to the execution of the suggested action item.

According to the present disclosure, even when there is no conversation between users, the conversation with the user can be made through the active utterance based on the information on the self-talk.

In addition, the user may be suggested whether to perform the action item, not just the active utterance.

In addition, the generation requirement of the related action item can be inferred based on the state monitoring of the electronic device used in the home related to the action item.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is an exemplary view of an analysis of an action item according to an embodiment of the present disclosure;

FIG. 2 is an exemplary view of a suggestion of an action item according to an embodiment of the present disclosure;

FIG. 3 is an exemplary view of a network environment to which an apparatus for suggesting an action item according to an embodiment of the present disclosure is connected;

FIG. 4 is a block diagram of the apparatus for suggesting an action item according to the embodiment of the present disclosure;

FIG. 5 is a block diagram of a memory in FIG. 4;

FIG. 6 is a block diagram of a learning device according to an embodiment of the present disclosure;

FIG. 7 is a flowchart of a method for suggesting an action item according to an embodiment of the present disclosure;

FIG. 8 is a flowchart of S140 in FIG. 7; and

FIG. 9 is a relationship diagram of components of the apparatus for suggesting an action item according to the embodiment of the present disclosure.

### DETAILED DESCRIPTION

The embodiments disclosed in the present specification will be described in greater detail with reference to the accompanying drawings, and throughout the accompanying drawings, the same reference numerals are used to designate the same or similar components and redundant descriptions thereof are omitted. As used herein, the terms “module” and “unit” used to refer to components are used interchangeably in consideration of convenience of explanation, and thus, the terms per se should not be considered as having different meanings or functions. Wherever possible, the same reference numbers will be used throughout the drawings to refer to the same or like parts. In the following description, known functions or structures, which may confuse the substance of the present disclosure, are not explained. Further, the accompanying drawings are provided for more understanding of the embodiment disclosed in the present specification, but the technical spirit disclosed in the present invention is not limited by the accompanying drawings. It should be understood that all changes, equivalents, and alternatives included in the spirit and the technical scope of the present invention are included.

Although the terms first, second, third, and the like, may be used herein to describe various elements, components, regions, layers, and/or sections, these elements, components, regions, layers, and/or sections should not be limited by these terms. These terms are generally used only to distinguish one element from another.

Similarly, it will be understood that when an element is referred to as being “connected,” “attached,” or “coupled” to another element, it can be directly connected, attached, or coupled to the other element, or intervening elements may be present. In contrast, when an element is referred to as being “directly on,” “directly engaged to,” “directly connected to,” or “directly coupled to” another element or layer, there may be no intervening elements or layers present.

An action item means a unit of documented event, business, activity, or task. Sometimes, action items are translated into what needs to be made as a result of a meeting. After the meeting, a list of the action items can be created and shared with people concerned.

An apparatus for suggesting an action item based on speech (hereinafter, apparatus for suggesting an action item) according to an embodiment of the present disclosure relates to an apparatus for suggesting a task that a user should practice in the future, that is, an action item through the voice based on speech information.

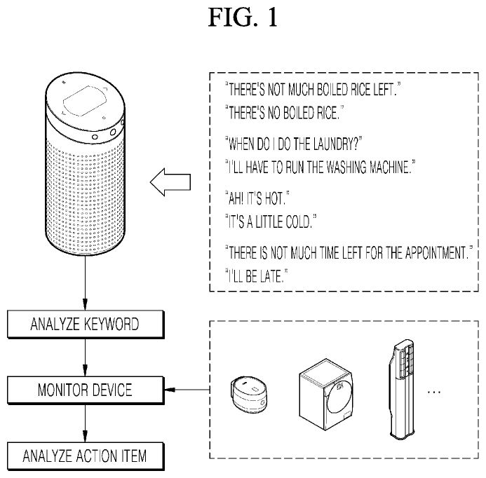

FIG. 1 is an exemplary view of an analysis of an action item according to an embodiment of the present disclosure.

Referring to FIG. 1, an apparatus for suggesting an action item according to an embodiment of the present disclosure is shown. The apparatus for suggesting an action item may analyze the action item through a keyword analysis and a device monitoring process based on a user's voice input. The action item may be related to a keyword uttered by a user or related to the operation of the monitored device. The apparatus for suggesting an action item may suggest the action item to the user based on the analyzed action item.

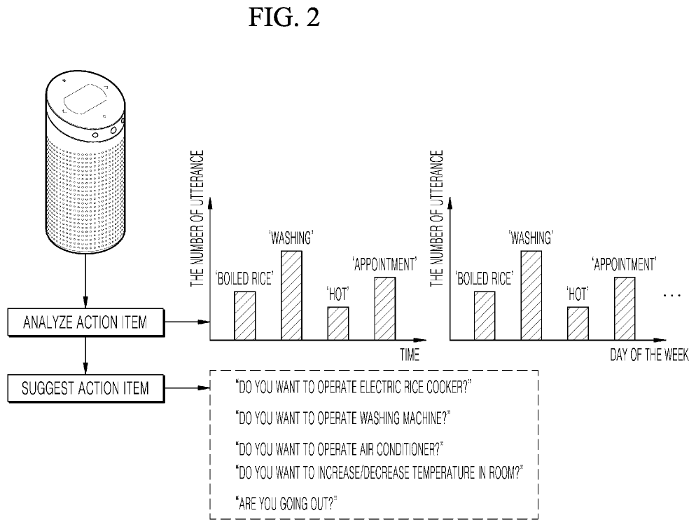

FIG. 2 is an exemplary view of a suggestion of an action item according to an embodiment of the present disclosure.

Referring to FIG. 2, the apparatus for suggesting an action item according to an embodiment of the present disclosure is shown. The apparatus for suggesting an action item may suggest the action item to the user using the analysis of the action item shown in FIG. 1. Statistical information regarding various keywords extracted from the user's voice as the analysis result of the action item is shown in FIG. 2. The suggestion of the action item based on the analysis of the action item may be made through a voice. The apparatus for suggesting an action item shown in FIGS. 1 and 2 is implemented in the form of a smart speaker among various embodiments. Hereinafter, various embodiments of the present disclosure will be described in detail.

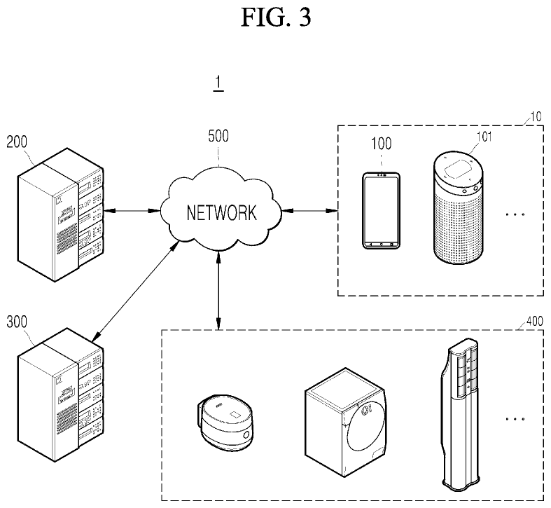

FIG. 3 is an exemplary view of a network environment to which the apparatus for suggesting an action item according to an embodiment of the present disclosure is connected.

Referring to FIG. 3, a network environment 1 configured to include an apparatus 10 for suggesting an action item, a learning device 200, various servers 300, various devices 400, and a network 500 through which these components are communicably connected to each other so that these components can communicate with each other is shown.

The apparatus 10 for suggesting an action item according to the embodiment of the present disclosure may be represented as a terminal 100 or a smart speaker 101 according to the implemented form, but is not limited to the range shown in FIG. 3.

When the apparatus 10 for suggesting an action item is a mobile terminal such as the terminal 100, the apparatus 10 for suggesting an action item may use its own location information to distinguish a case where the apparatus for suggesting an action item is in a user's home and a case where the apparatus for suggesting an action item is outside a home, for example, a case where the apparatus for suggesting an action item is in an office, thereby suggesting action items that should be performed at that location.

Hereinafter, among various embodiments of the apparatus 10 for suggesting an action item, the apparatus 10 for suggesting an action item according to an embodiment of the present disclosure will be described focusing on the terminal 100 and the smart speaker 101. If there is no other special assumptions or conditions, the description of one of the terminal 100 and the smart speaker 101 corresponding to the apparatus 10 for suggesting an action item, which may be implemented as a common component, may be applied to the other.

The apparatus 10 for suggesting an action item may recognize a user's voice independently or by using various servers 300, for example, a speech recognizer, and convert the voice into text. In addition, the apparatus 10 for suggesting an action item may extract keywords from text independently or by using various servers 300, for example, a natural language processing server.

The apparatus 10 for suggesting an action item may analyze the action item using the learning device 200 and suggest the action item in advance using the analysis result. That is, the apparatus 10 for suggesting an action item may analyze the action item using an artificial intelligence model trained by the learning device 200, for example, a deep neural network, and infer the action item to be performed by a user based on the analysis result. Details of the artificial intelligence will be described below.

In addition, the apparatus 10 for suggesting an action item may again train a primarily trained artificial intelligence model, for example, a deep neural network, using a user's personal database, that is, directly collected voice data and device monitoring data, as a training data set. To this end, the apparatus 10 for suggesting an action item may collect the monitoring data for analyzing the action item through the monitoring of the device 400 while collecting the voice data for analyzing the action item from the user.

The learning device 200 may train and evaluate the learning of an artificial intelligence model used for the speech recognition, the analysis of the action item, and the suggestion of the action item, for example, various deep neural networks, according to the embodiment of the present disclosure. The evaluated artificial intelligence model may be used by the apparatus 10 for suggesting an action item while being stored in the learning device 200, the server 300, or the apparatus 10 for suggesting an action item. Details of the learning device 200 will be described below.

The range of the server 300 may include a plurality of servers that performs various functions. The plurality of servers 300 may provide a speech recognition function and a natural language processing function to the apparatus 10 for suggesting an action item or provide a web service, an application service, a file, a database, a cloud service, and the like to the apparatus 10 for suggesting an action item.

The range of the device 400 may include home electronic devices and office devices related to the user's action item, for example, an electric rice cooker, a washing machine, an air conditioner, and the like, as shown in FIG. 3. Since the device 400 is equipped with an embedded system and an Internet of things (IoT) function, the driving of the device 400 may be controlled by the apparatus 10 for suggesting an action item through communication.

The network 500 may be an appropriate communication network including wired and wireless networks, such as a local area network (LAN), a wide area network (WAN), the Internet, the Intranet, and the extranet and a mobile network such as cellular, 3G, LTE, 5G, a Wi-Fi network, an AD hoc network, and a combination thereof.

The network 500 may include connection of network elements such as a hub, a bridge, a router, a switch, and a gateway. The network 500 may include one or more connected networks including a public network such as the Internet and a private network such as a secure corporate private network, for example, multiple network environments. Access to the network 500 may be provided by one or more wired or wireless access networks.

The terminal 100 may transmit and receive data to and from the learning device 200 and the server 300 through a 5G network. In particular, the apparatus 10 for suggesting an action item based on speech may perform data communication with the learning device 200 using at least one of enhanced mobile broadband (eMBB), ultra-reliable and low latency communications (URLLC), and massive machine-type communications (MMTC) over a 5G network.

The enhanced mobile broadband (eMBB) which is a mobile broadband service provides multimedia contents, wireless data access, and so forth. Further, more improved mobile services such as a hotspot and a wideband coverage for receiving mobile traffic that are tremendously increasing can be provided through eMBB. Through a hotspot, the large-volume traffic may be accommodated in an area where user mobility is low and user density is high. Through broadband coverage, a wide-range and stable wireless environment and user mobility may be guaranteed.

The URLLC service defines the requirements that are far more stringent than existing LTE in terms of reliability and transmission delay of data transmission and reception, and corresponds to a 5G service for production process automation in the industrial field, telemedicine, remote surgery, transportation, safety, and the like.

mMTC is a transmission delay-insensitive service that requires a relatively small amount of data transmission. A much larger number of terminals, such as sensors, than a general portable phone may be connected to a wireless access network by mMTC at the same time. In this case, the price of the communication module of a terminal should be low and a technology improved to increase power efficiency and save power is required to enable operation for several years without replacing or recharging a battery.

The artificial intelligence (AI) is one field of computer science and information technology that studies methods to make computers mimic intelligent human behaviors such as reasoning, learning, self-improving and the like.

In addition, the artificial intelligence does not exist on its own, but is rather directly or indirectly related to a number of other fields in computer science. In recent years, there have been numerous attempts to introduce an element of the artificial intelligence into various fields of information technology to solve problems in the respective fields.

Machine learning is an area of artificial intelligence that includes the field of study that gives computers the capability to learn without being explicitly programmed.

Specifically, the Machine Learning can be a technology for researching and constructing a system for learning, predicting, and improving its own performance based on empirical data and an algorithm for the same. The algorithms of the Machine Learning take a method of constructing a specific model in order to obtain the prediction or the determination based on the input data, rather than performing the strictly defined static program instructions.

Numerous machine learning algorithms have been developed for data classification in machine learning. Representative examples of such machine learning algorithms for data classification include a decision tree, a Bayesian network, a support vector machine (SVM), an artificial neural network (ANN), and so forth.

Decision tree refers to an analysis method that uses a tree-like graph or model of decision rules to perform classification and prediction.

Bayesian network may include a model that represents the probabilistic relationship (conditional independence) among a set of variables. Bayesian network may be appropriate for data mining via unsupervised learning.

SVM may include a supervised learning model for pattern detection and data analysis, heavily used in classification and regression analysis.

ANN is a data processing system modelled after the mechanism of biological neurons and interneuron connections, in which a number of neurons, referred to as nodes or processing elements, are interconnected in layers.

ANNs are models used in machine learning and may include statistical learning algorithms conceived from biological neural networks (particularly of the brain in the central nervous system of an animal) in machine learning and cognitive science.

ANNs may refer generally to models that have artificial neurons (nodes) forming a network through synaptic interconnections, and acquires problem-solving capability as the strengths of synaptic interconnections are adjusted throughout training.

The terms ‘artificial neural network’ and ‘neural network’ may be used interchangeably herein.

An ANN may include a number of layers, each including a number of neurons. In addition, the Artificial Neural Network can include the synapse for connecting between neuron and neuron.

An ANN may be defined by the following three factors: (1) a connection pattern between neurons on different layers; (2) a learning process that updates synaptic weights; and (3) an activation function generating an output value from a weighted sum of inputs received from a lower layer.

ANNs include, but are not limited to, network models such as a deep neural network (DNN), a recurrent neural network (RNN), a bidirectional recurrent deep neural network (BRDNN), a multilayer perception (MLP), and a convolutional neural network (CNN).

An ANN may be classified as a single-layer neural network or a multi-layer neural network, based on the number of layers therein.

A general Single-Layer Neural Network is composed of an input layer and an output layer.

In addition, a general Multi-Layer Neural Network is composed of an Input layer, one or more Hidden layers, and an Output layer.

The Input layer is a layer that accepts external data, the number of neurons in the Input layer is equal to the number of input variables, and the Hidden layer is disposed between the Input layer and the Output layer and receives a signal from the Input layer to extract the characteristics to transfer it to the Output layer. The Output layer receives a signal from the Hidden layer, and outputs an output value based on the received signal. The Input signal between neurons is multiplied by each connection strength (weight) and then summed, and if the sum is larger than the threshold of the neuron, the neuron is activated to output the output value obtained through the activation function.

A deep neural network with a plurality of hidden layers between the input layer and the output layer may be the most representative type of artificial neural network which enables deep learning, which is one machine learning technique.

The Artificial Neural Network can be trained by using training data. Herein, the training can mean a process of determining a parameter of the Artificial Neural Network by using training data in order to achieve the objects such as classification, regression, clustering, etc. of input data. As a representative example of the parameter of the Artificial Neural Network, there can be a weight given to a synapse or a bias applied to a neuron.

The Artificial Neural Network trained by the training data can classify or cluster the input data according to the pattern of the input data.

Meanwhile, the Artificial Neural Network trained by using the training data can be referred to as a trained model in the present specification.

Next, the learning method of the Artificial Neural Network will be described.

The learning method of the Artificial Neural Network can be largely classified into Supervised Learning, Unsupervised Learning, Semi-supervised Learning, and Reinforcement Learning.

The Supervised Learning is a method of the Machine Learning for inferring one function from the training data.

Then, among the thus inferred functions, outputting consecutive values is referred to as regression, and predicting and outputting a class of an input vector is referred to as classification.

In the Supervised Learning, the Artificial Neural Network is learned in a state where a label for the training data has been given.

Here, the label may refer to a target answer (or a result value) to be guessed by the artificial neural network when the training data is inputted to the artificial neural network.

Throughout the present specification, the target answer (or a result value) to be guessed by the artificial neural network when the training data is inputted may be referred to as a label or labeling data.

In addition, in the present specification, setting the label to the training data for training of the Artificial Neural Network is referred to as labeling the labeling data on the training data.

Training data and labels corresponding to the training data together may form a single training set, and as such, they may be inputted to an artificial neural network as a training set.

Meanwhile, the training data represents a plurality of features, and the labeling the label on the training data can mean that the feature represented by the training data is labeled. In this case, the training data can represent the feature of the input object in the form of a vector.

The Artificial Neural Network can infer a function of the relationship between the training data and the labeling data by using the training data and the labeling data. Then, the parameter of the Artificial Neural Network can be determined (optimized) by evaluating the function inferred from the Artificial Neural Network.

Unsupervised learning is a machine learning method that learns from training data that has not been given a label.

More specifically, unsupervised learning may be a training scheme that trains an artificial neural network to discover a pattern within given training data and perform classification by using the discovered pattern, rather than by using a correlation between given training data and labels corresponding to the given training data.

Examples of unsupervised learning include, but are not limited to, clustering and independent component analysis.

Examples of artificial neural networks using unsupervised learning include, but are not limited to, a generative adversarial network (GAN) and an autoencoder (AE).

GAN is a machine learning method in which two different artificial intelligences, a generator and a discriminator, improve performance through competing with each other.

The generator may be a model generating new data that generates new data based on true data.

The discriminator may be a model recognizing patterns in data that determines whether inputted data is from the true data or from the new data generated by the generator.

Furthermore, the generator may receive and learn from data that has failed to fool the discriminator, while the discriminator may receive and learn from data that has succeeded in fooling the discriminator. Accordingly, the generator may evolve so as to fool the discriminator as effectively as possible, while the discriminator evolves so as to distinguish, as effectively as possible, between the true data and the data generated by the generator.

An auto-encoder (AE) is a neural network which aims to reconstruct its input as output.

More specifically, AE may include an input layer, at least one hidden layer, and an output layer.

Since the number of nodes in the hidden layer is smaller than the number of nodes in the input layer, the dimensionality of data is reduced, thus leading to data compression or encoding.

Furthermore, the data outputted from the hidden layer may be inputted to the output layer. Given that the number of nodes in the output layer is greater than the number of nodes in the hidden layer, the dimensionality of the data increases, thus leading to data decompression or decoding.

Furthermore, in the AE, the inputted data is represented as hidden layer data as interneuron connection strengths are adjusted through training. The fact that when representing information, the hidden layer is able to reconstruct the inputted data as output by using fewer neurons than the input layer may indicate that the hidden layer has discovered a hidden pattern in the inputted data and is using the discovered hidden pattern to represent the information.

Semi-supervised learning is machine learning method that makes use of both labeled training data and unlabeled training data.

One semi-supervised learning technique involves reasoning the label of unlabeled training data, and then using this reasoned label for learning. This technique may be used advantageously when the cost associated with the labeling process is high.

Reinforcement learning may be based on a theory that given the condition under which a reinforcement learning agent can determine what action to choose at each time instance, the agent can find an optimal path to a solution solely based on experience without reference to data.

The Reinforcement Learning can be mainly performed by a Markov Decision Process (MDP).

Markov decision process consists of four stages: first, an agent is given a condition containing information required for performing a next action; second, how the agent behaves in the condition is defined; third, which actions the agent should choose to get rewards and which actions to choose to get penalties are defined; and fourth, the agent iterates until future reward is maximized, thereby deriving an optimal policy.

An artificial neural network is characterized by features of its model, the features including an activation function, a loss function or cost function, a learning algorithm, an optimization algorithm, and so forth. Also, the hyperparameters are set before learning, and model parameters can be set through learning to specify the architecture of the artificial neural network.

For instance, the structure of an artificial neural network may be determined by a number of factors, including the number of hidden layers, the number of hidden nodes included in each hidden layer, input feature vectors, target feature vectors, and so forth.

Hyperparameters may include various parameters which need to be initially set for learning, much like the initial values of model parameters. Also, the model parameters may include various parameters sought to be determined through learning.

For instance, the hyperparameters may include initial values of weights and biases between nodes, mini-batch size, iteration number, learning rate, and so forth. Furthermore, the model parameters may include a weight between nodes, a bias between nodes, and so forth.

Loss function may be used as an index (reference) in determining an optimal model parameter during the learning process of an artificial neural network. Learning in the artificial neural network involves a process of adjusting model parameters so as to reduce the loss function, and the purpose of learning may be to determine the model parameters that minimize the loss function.

Loss functions typically use means squared error (MSE) or cross entropy error (CEE), but the present disclosure is not limited thereto.

Cross-entropy error may be used when a true label is one-hot encoded. One-hot encoding may include an encoding method in which among given neurons, only those corresponding to a target answer are given 1 as a true label value, while those neurons that do not correspond to the target answer are given 0 as a true label value.

In machine learning or deep learning, learning optimization algorithms may be deployed to minimize a cost function, and examples of such learning optimization algorithms include gradient descent (GD), stochastic gradient descent (SGD), momentum, Nesterov accelerated gradient (NAG), Adagrad, AdaDelta, RMSProp, Adam, and Nadam.

GD includes a method that adjusts model parameters in a direction that decreases the output of a cost function by using a current slope of the cost function.

The direction in which the model parameters are to be adjusted may be referred to as a step direction, and a size by which the model parameters are to be adjusted may be referred to as a step size.

Here, the step size may mean a learning rate.

GD obtains a slope of the cost function through use of partial differential equations, using each of model parameters, and updates the model parameters by adjusting the model parameters by a learning rate in the direction of the slope.

SGD may include a method that separates the training dataset into mini batches, and by performing gradient descent for each of these mini batches, increases the frequency of gradient descent.

Adagrad, AdaDelta and RMSProp may include methods that increase optimization accuracy in SGD by adjusting the step size, and may also include methods that increase optimization accuracy in SGD by adjusting the momentum and step direction. Adam may include a method that combines momentum and RMSProp and increases optimization accuracy in SGD by adjusting the step size and step direction. Nadam may include a method that combines NAG and RMSProp and increases optimization accuracy by adjusting the step size and step direction.

Learning rate and accuracy of an artificial neural network rely not only on the structure and learning optimization algorithms of the artificial neural network but also on the hyperparameters thereof. Therefore, in order to obtain a good learning model, it is important to choose a proper structure and learning algorithms for the artificial neural network, but also to choose proper hyperparameters.

In general, the artificial neural network is first trained by experimentally setting hyperparameters to various values, and based on the results of training, the hyperparameters can be set to optimal values that provide a stable learning rate and accuracy.

In addition, the apparatus 10 for suggesting an action item may relearn the AI model trained by the learning device 200 using user's personal data based on a transfer learning method. The apparatus 10 for suggesting an action item may use various AI application programs provided from the learning device 200 or the server 300 during the execution or relearning of the AI model.

According to an embodiment of the present disclosure, as the method for analyzing an action item based on the deep neural network, for example, the deep learning, two methods may be used largely. Of the two methods, one method is to train a deep learning model from the beginning, and the other is to use an already trained deep learning model.

The basic training of the deep learning models, that is, the training of the deep network requires a process of gathering vast training data sets, designing network architecture to learn features, and completing a model. Excellent results can be obtained by the training of the deep network, but this approach requires vast training data sets and setting of layers and weights in the used network, for example, CNN.

A plurality of deep learning application programs used in the pre-trained deep learning model may use transfer learning which is a process including a method for finely tuning a pre-trained model. In this transfer learning method, new data including previously unknown classes can be injected into deep networks, for example, the existing deep networks such as AlexNet or GoogLeNet.

According to the transfer method, the model is pre-trained with voice data and monitoring data which correspond to big data, so time consumption can be reduced and results can be calculated quickly.

The deep learning model provides a high level of precision in the analysis of the action item using the voice data and the monitoring data but requires a large amount of training data sets for accurate prediction.

The apparatus 10 for suggesting an action item according to the embodiment of the present disclosure is one of the deep learning models, and collects the user's voice data and the monitoring data of the device as input data, and can use the CNN model trained using the collected user's voice data and monitoring data. The CNN may classify the action items related to the input data by classifying the extracted features into a unique category.

The analysis of the action item based on the machine learning based-voice data and monitoring data may include a process of manually extracting features and classifying the extracted features. For example, HOG feature extraction using a support vector machine (SVM) machine learning algorithm may be used as an embodiment of the present disclosure. As other feature extraction algorithms, Harris corner, Shi & Tomasi, SIFT-DoG, FAST, AGAST, and main invariant feature quantities (SURF, BRIEF, ORB) methods may be used.

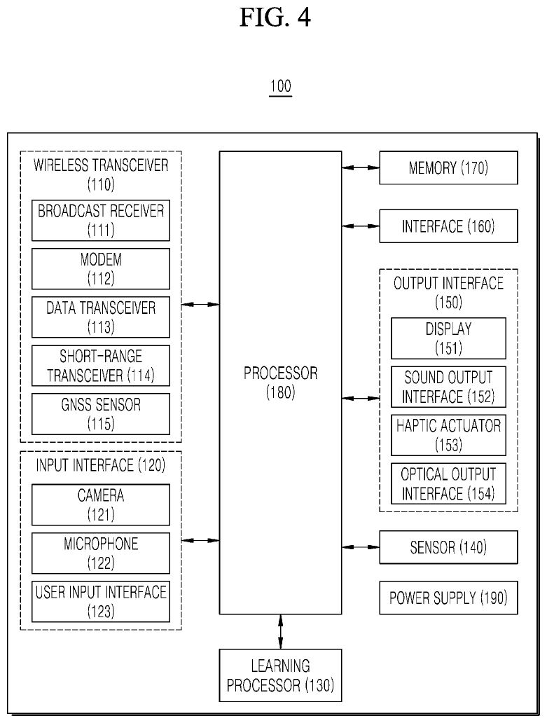

FIG. 4 is a block diagram of the apparatus for suggesting an action item according to the embodiment of the present disclosure. The block diagram of FIG. 4 is based on the terminal 100 in the apparatus 10 for suggesting an action item but may be applied to the smart speaker 101.

The terminal 100 may be implemented as a stationary terminal and a mobile terminal, such as a mobile phone, a projector, a mobile phone, a smartphone, a laptop computer, a terminal for digital broadcast, a personal digital assistant (PDA), a portable multimedia player (PMP), a navigation system, a slate PC, a tablet PC, an ultrabook, a wearable device (for example, a smartwatch, a smart glass, and a head mounted display (HMD)), a set-top box (STB), a digital multimedia broadcast (DMB) receiver, a radio, a laundry machine, a refrigerator, a desktop computer, a digital signage.

That is, the terminal 100 may be implemented as various home appliances used at home and also applied to a fixed or mobile robot.

The terminal 100 may perform a function of a voice agent. The voice agent may be a program which recognizes a voice of the user and outputs a response appropriate for the recognized voice of the user as a voice.

Referring to FIG. 4, the terminal 100 may include a wireless transceiver 110, an input interface 120, a learning processor 130, a sensor 130, an output interface 150, an interface 160, a memory 170, a processor 180, and a power supply 190.

A trained model may be loaded in the terminal 100.

In the meantime, the learning model may be implemented by hardware, software, or a combination of hardware and software. When a part or all of the learning model is implemented by software, one or more commands which configure the learning model may be stored in the memory 170.

The wireless transceiver 110 may include at least one of a broadcast receiver 111, a modem 112, a data transceiver 113, a short-range transceiver 114, and a GNSS sensor 115.

The broadcast receiver 111 receives a broadcasting signal and/or broadcasting related information from an external broadcasting management server through a broadcasting channel.

The modem 112 may transmit/receive a wireless signal to/from at least one of a base station, an external terminal, and a server on a mobile communication network established according to the technical standards or communication methods for mobile communication (for example, Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), and Long Term Evolution-Advanced (LTE-A)).

The data transceiver 113 refers to a module for wireless internet access and may be built in or external to the terminal 100. The data transceiver 113 may be configured to transmit/receive a wireless signal in a communication network according to wireless internet technologies.

The wireless internet technologies may include Wireless LAN (WLAN), Wireless-Fidelity (Wi-Fi), Wi-Fi Direct, Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), and Long Term Evolution-Advanced (LTE-A).

The short-range transceiver 114 may support Short-range communication by using at least one of Bluetooth™, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (USB) technologies.

The GNSS sensor 115 is a module for obtaining the location (or the current location) of a mobile terminal, and its representative examples include a global positioning system (GPS) module or a Wi-Fi module. For example, the mobile terminal may obtain its position by using a signal transmitted from a GPS satellite through the GPS module.

The input interface 120 may include a camera 121 which inputs an image signal, a microphone 122 which receives an audio signal, and a user input interface 123 which receives information from the user.

Voice data or image data collected by the input interface 120 is analyzed to be processed as a control command of the user.

The input interface 120 may obtain training data for training a model and input data used to obtain an output using the trained model.

The input interface 120 may obtain input data which is not processed, and, in this case, the processor 180 or the learning processor 130 pre-processes the obtained data to generate training data to be input to the model learning or pre-processed input data.

In this case, the pre-processing on the input data may refer to extracting of an input feature from the input data.

The input interface 120 is provided to input image information (or signal), audio information (or signal), data, or information input from the user and in order to input the image information, the terminal 100 may include one or a plurality of cameras 121.

The camera 121 processes an image frame such as a still image or a moving image obtained by an image sensor in a video call mode or a photographing mode. The processed image frame may be displayed on the display 151 or stored in the memory 170.

The microphone 122 processes an external sound signal as electrical voice data. The processed voice data may be utilized in various forms in accordance with a function which is being performed by the terminal 100 (or an application program which is being executed). In the meantime, in the microphone 122, various noise removal algorithms which remove a noise generated during the process of receiving the external sound signal may be implemented.

The user input interface 123 receives information from the user and when the information is input through the user input interface 123, the processor 180 may control the operation of the terminal 100 so as to correspond to the input information.

The user input interface 123 may include a mechanical input interface (or a mechanical key, for example, a button located on a front, rear, or side surface of the terminal 100, a dome switch, a jog wheel, or a jog switch) and a touch type input interface. For example, the touch type input interface may be formed by a virtual key, a soft key, or a visual key which is disposed on the touch screen through a software process or a touch key which is disposed on a portion other than the touch screen.

The learning processor 130 learns the model configured by an artificial neural network using the training data.

Specifically, the learning processor 130 repeatedly trains the artificial neural network using the aforementioned various learning techniques to determine optimized model parameters of the artificial neural network.

In this specification, the artificial neural network which is trained using training data to determine parameters may be referred to as a learning model or a trained model.

In this case, the learning model may be used to deduce a result for the new input data, rather than the training data.

The learning processor 130 may be configured to receive, classify, store, and output information to be used for data mining, data analysis, intelligent decision making, and machine learning algorithm and techniques.

The learning processor 130 may include one or more memory units configured to store data which is received, detected, sensed, generated, previously defined, or output by another component, device, the terminal, or a device which communicates with the terminal.

The learning processor 130 may include a memory which is combined with or implemented in the terminal. In some exemplary embodiments, the learning processor 130 may be implemented using the memory 170.

Selectively or additionally, the learning processor 130 may be implemented using a memory related to the terminal, such as an external memory which is directly coupled to the terminal or a memory maintained in the server which communicates with the terminal.

According to another exemplary embodiment, the learning processor 130 may be implemented using a memory maintained in a cloud computing environment or other remote memory locations accessible by the terminal via a communication method such as a network.

The learning processor 130 may be configured to store data in one or more databases to identify, index, categorize, manipulate, store, search, and output data in order to be used for supervised or non-supervised learning, data mining, predictive analysis, or used in the other machine. Here, the database may be implemented using the memory 170, a memory 230 of the learning device 200, a memory maintained in a cloud computing environment or other remote memory locations accessible by the terminal via a communication method such as a network.

Information stored in the learning processor 130 may be used by the processor 180 or one or more controllers of the terminal using an arbitrary one of different types of data analysis algorithms and machine learning algorithms

As an example of such an algorithm, a k-nearest neighbor system, fuzzy logic (for example, possibility theory), a neural network, a Boltzmann machine, vector quantization, a pulse neural network, a support vector machine, a maximum margin classifier, hill climbing, an inductive logic system, a Bayesian network, (for example, a finite state machine, a Mealy machine, a Moore finite state machine), a classifier tree (for example, a perceptron tree, a support vector tree, a Markov Tree, a decision tree forest, an arbitrary forest), a reading model and system, artificial fusion, sensor fusion, image fusion, reinforcement learning, augmented reality, pattern recognition, automated planning, and the like, may be provided.

The processor 180 may determine or predict at least one executable operation of the terminal based on information which is determined or generated using the data analysis and the machine learning algorithm. To this end, the processor 180 may request, search, receive, or utilize the data of the learning processor 130 and control the terminal to execute a predicted operation or a desired operation among the at least one executable operation.

The processor 180 may perform various functions which implement intelligent emulation (that is, a knowledge based system, an inference system, and a knowledge acquisition system). This may be applied to various types of systems (for example, a fuzzy logic system) including an adaptive system, a machine learning system, and an artificial neural network.

The processor 180 may include sub modules which enable operations involving voice and natural language voice processing, such as an I/O processing module, an environmental condition module, a speech to text (STT) processing module, a natural language processing module, a workflow processing module, and a service processing module.

The sub modules may have an access to one or more systems or data and a model, or a subset or a super set thereof in the terminal. Further, each of the sub modules may provide various functions including a glossarial index, user data, a workflow model, a service model, and an automatic speech recognition (ASR) system.

According to another exemplary embodiment, another aspect of the processor 180 or the terminal may be implemented by the above-described sub module, a system, data, and a model.

In some exemplary embodiments, based on the data of the learning processor 130, the processor 180 may be configured to detect and sense requirements based on contextual conditions expressed by user input or natural language input or user's intention.

The processor 180 may actively derive and obtain information required to completely determine the requirement based on the contextual conditions or the user's intention. For example, the processor 180 may actively derive information required to determine the requirements, by analyzing past data including historical input and output, pattern matching, unambiguous words, and input intention.

The processor 180 may determine a task flow to execute a function responsive to the requirements based on the contextual condition or the user's intention.

The processor 180 may be configured to collect, sense, extract, detect and/or receive a signal or data which is used for data analysis and a machine learning task through one or more sensing components in the terminal, to collect information for processing and storing in the learning processor 130.

The information collection may include sensing information by a sensor, extracting of information stored in the memory 170, or receiving information from other equipment, an entity, or an external storage device through a transceiver.

The processor 180 collects usage history information from the terminal and stores the information in the memory 170.

The processor 180 may determine best matching to execute a specific function using stored usage history information and predictive modeling.

The processor 180 may receive or sense surrounding environment information or other information through the sensor 140.

The processor 180 may receive a broadcasting signal and/or broadcasting related information, a wireless signal, or wireless data through the wireless transceiver 110.

The processor 180 may receive image information (or a corresponding signal), audio information (or a corresponding signal), data, or user input information from the input interface 120.

The processor 180 may collect the information in real time, process or classify the information (for example, a knowledge graph, a command policy, a personalized database, or a conversation engine) and store the processed information in the memory 170 or the learning processor 130.

When the operation of the terminal is determined based on data analysis and a machine learning algorithm and technology, the processor 180 may control the components of the terminal to execute the determined operation. Further, the processor 180 may control the equipment in accordance with the control command to perform the determined operation.

When a specific operation is performed, the processor 180 analyzes history information indicating execution of the specific operation through the data analysis and the machine learning algorithm and technology and updates the information which is previously learned based on the analyzed information.

Therefore, the processor 180 may improve precision of a future performance of the data analysis and the machine learning algorithm and technology based on the updated information, together with the learning processor 130.

The sensor 140 may include one or more sensors which sense at least one of information in the mobile terminal, surrounding environment information around the mobile terminal, and user information.

For example, the sensor 140 may include at least one of a proximity sensor, an illumination sensor, a touch sensor, an acceleration sensor, a magnetic sensor, a G-sensor, a gyroscope sensor, a motion sensor, an RGB sensor, an infrared (IR) sensor, a finger scan sensor, an ultrasonic sensor, an optical sensor (for example, a camera 121), a microphone 122, a battery gauge, an environment sensor (for example, a barometer, a hygrometer, a thermometer, a radiation sensor, a thermal sensor, or a gas sensor), and a chemical sensor (for example, an electronic nose, a healthcare sensor, or a biometric sensor). On the other hand, the terminal 100 disclosed in the present disclosure may combine various kinds of information sensed by at least two of the above-mentioned sensors and may use the combined information.

The output interface 150 is intended to generate an output related to a visual, aural, or tactile stimulus and may include at least one of a display 151, sound output interface 152, haptic actuator 153, and optical output interface 154.

The display 151 displays (outputs) information processed in the terminal 100. For example, the display 151 may display execution screen information of an application program driven in the terminal 100 and user interface (UI) and graphic user interface (GUI) information in accordance with the execution screen information.

The display 151 forms a mutual layered structure with a touch sensor or is formed integrally to be implemented as a touch screen. The touch screen may simultaneously serve as a user input interface 123 which provides an input interface between the terminal 100 and the user and provide an output interface between the terminal 100 and the user.

The sound output interface 152 may output audio data received from the wireless transceiver 110 or stored in the memory 170 in a call signal reception mode, a phone-call mode, a recording mode, a speech recognition mode, or a broadcasting reception mode.

The sound output interface 152 may include at least one of a receiver, a speaker, and a buzzer.

The haptic actuator 153 may generate various tactile effects that the user may feel. A representative example of the tactile effect generated by the haptic actuator 153 may be vibration.

The optical output interface 154 outputs a signal for notifying occurrence of an event using light of a light source of the terminal 100. Examples of the event generated in the terminal 100 may be message reception, call signal reception, missed call, alarm, schedule notification, email reception, and information reception through an application.

The interface 160 serves as a passage with various types of external devices which are connected to the terminal 100. The interface 160 may include at least one of a wired/wireless headset port, an external charger port, a wired/wireless data port, a memory card port, a port which connects a device equipped with an identification module, an audio input/output (I/O) port, a video input/output (I/O) port, and an earphone port. The terminal 100 may perform appropriate control related to the connected external device in accordance with the connection of the external device to the interface 160.

In the meantime, the identification module is a chip in which various information for authenticating a usage right of the terminal 100 is stored and includes a user identification module (UIM), a subscriber identify module (SIM), and a universal subscriber identity module (USIM). The device with an identification module (hereinafter, “identification device”) may be manufactured as a smart card. Therefore, the identification device may be connected to the terminal 100 through the interface 160.

The memory 170 stores data which supports various functions of the terminal 100.

The memory 170 may store various application programs (or applications) driven in the terminal 100, data for the operation of the terminal 100, commands, and data (for example, at least one algorithm information for machine learning) for the operation of the learning processor 130.

The memory 170 may store the model which is learned in the learning processor 130 or the learning device 200.

If necessary, the memory 170 may store the trained model by dividing the model into a plurality of versions depending on a training timing or a training progress.

In this case, the memory 170 may store input data obtained from the input interface 120, learning data (or training data) used for model learning, a learning history of the model, and so forth.

In this case, the input data stored in the memory 170 may be not only data which is processed to be suitable for the model learning but also input data itself which is not processed.

In addition to the operation related to the application program, the processor 180 may generally control an overall operation of the terminal 100. The processor 180 may process a signal, data, or information which is input or output through the above-described components or drives the application programs stored in the memory 170 to provide or process appropriate information or functions to the user.

Further, in order to drive the application program stored in the memory 170, the processor 180 may control at least some of components described with reference to FIG. 4. Moreover, the processor 180 may combine and operate at least two of components included in the terminal 100 to drive the application program.

In the meantime, as described above, the processor 180 may control an operation related to the application program and an overall operation of the terminal 100. For example, when the state of the terminal satisfies a predetermined condition, the processor 180 may execute or release a locking state which restricts an input of a control command of a user for the applications.

The power supply 190 is applied with external power or internal power to supply the power to the components included in the terminal 100 under the control of the processor 180. The power supply 190 includes a battery and the battery may be an embedded battery or a replaceable battery.

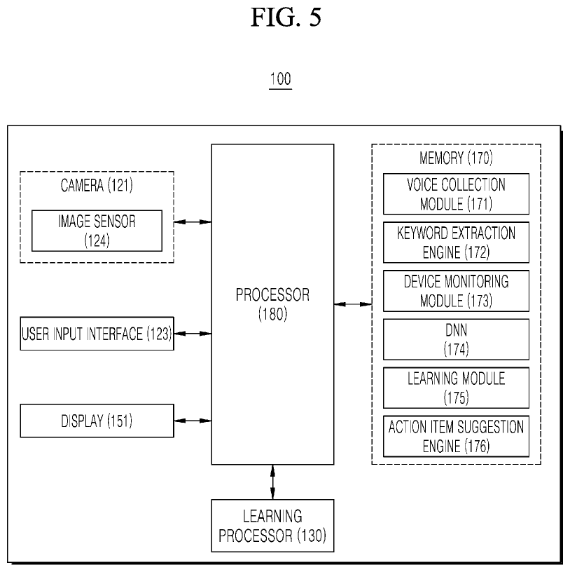

FIG. 5 is a block diagram of the memory in FIG. 4.

Referring to FIG. 5, components of the memory 170 included in the terminal 100 as the apparatus 10 for suggesting an action item are briefly shown. In the memory 170, various computer program modules may be loaded. In addition to an operating system and a system program for managing hardware in a range of computer programs loaded in the memory 170, the application program may include a voice collection module 171, a keyword extraction engine 172, a device monitoring module 173, and a deep neural network (DNN) 174, a learning module 175, and an action item suggestion engine 176.

A function of activating a microphone using user motion detection to collect a user voice related to the voice collection module 171, a function of collecting a user voice, for example, a user's self-talk while the microphone is activated, a function of converting the collected voice into digital, and a speech recognition function of converting voice data into text may be performed through various computation functions of the processor 180.

The function of extracting a keyword related to an action item from text converted through the speech recognition through the natural language processing related to the keyword extraction engine 172 may be performed through various computation functions of the processor 180.

The function of monitoring the device operated after the utterance of the self-talk which is related to the device monitoring module 173 may be performed through various computation functions of the processor 180.

The speech recognition related to the deep neural network (DNN) 174, the function of using the deep neural network in the natural language processing, and the function of classifying the action items through the analysis of the action items may be performed through various computation functions of the processor 180.

The function of re-learning the pre-trained artificial intelligence model, for example, the deep neural network using the user's personal data related to the learning module 175 may be performed through various computation functions of the processor 180 or the learning processor 130.

The function of suggesting an action item through the inference of the action item to be performed by the user based on the analysis of the action item related to the action item suggestion engine 176 may be performed through various computation functions of the processor 180.

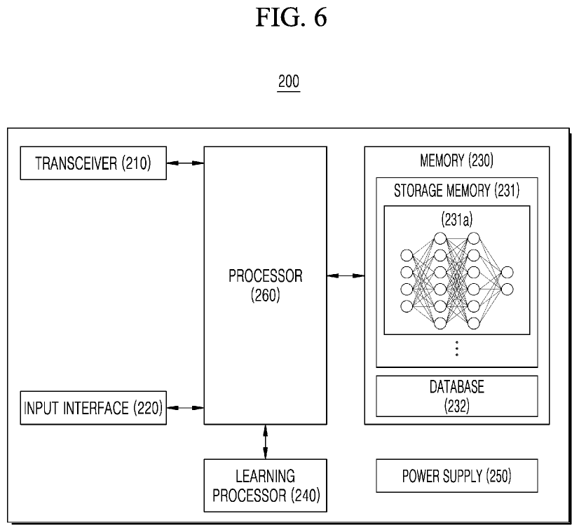

FIG. 6 is a block diagram of the learning device according to the embodiment of the present disclosure.

The learning device 200 is a device or a server which is separately configured at the outside of the terminal 100 and may perform the same function as the learning processor 130 of the terminal 100.

That is, the learning device 200 may be configured to receive, classify, store, and output information to be used for data mining, data analysis, intelligent decision making, and machine learning algorithms Here, the machine learning algorithm may include a deep learning algorithm.

The learning device 200 may communicate with at least one terminal 100 and derive a result by analyzing or learning the data on behalf of the terminal 100. Here, the meaning of “on behalf of the other device” may be distribution of a computing power by means of distributed processing.

The learning device 200 of the artificial neural network is various devices for learning an artificial neural network and normally, refers to a server, and also referred to as a learning device or a learning server.

Specifically, the learning device 200 may be implemented not only by a single server, but also by a plurality of server sets, a cloud server, or a combination thereof.

That is, the learning device 200 is configured as a plurality of learning devices to configure a learning device set (or a cloud server) and at least one learning device 200 included in the learning device set may derive a result by analyzing or learning the data through the distributed processing.

The learning device 200 may transmit a model trained by the machine learning or the deep learning to the terminal 100 periodically or upon the request.

Referring to FIG. 6, the learning device 200 may include a transceiver 210, an input interface 220, a memory 230, a learning processor 240, a power supply 250, a processor 260, and so forth.

The transceiver 210 may correspond to a configuration including the wireless transceiver 110 and the interface 160 of FIG. 4. That is, the transceiver may transmit and receive data with the other device through wired/wireless communication or an interface.

The input interface 220 is a configuration corresponding to the input interface 120 of FIG. 4 and may receive the data through the transceiver 210 to obtain data.

The input interface 220 may obtain input data for acquiring an output using training data for model learning and a trained model.

The input interface 220 may obtain input data which is not processed, and, in this case, the processor 260 may pre-process the obtained data to generate training data to be input to the model learning or pre-processed input data.

In this case, the pre-processing on the input data performed by the input interface 220 may refer to extracting of an input feature from the input data.

The memory 230 is a configuration corresponding to the memory 170 of FIG. 4.

The memory 230 may include a storage memory 231, a database 232, and so forth.

The storage memory 231 stores a model (or an artificial neural network 231a) which is learning or trained through the learning processor 240 and when the model is updated through the learning, stores the updated model.

If necessary, the storage memory 231 stores the trained model by dividing the model into a plurality of versions depending on a training timing or a training progress.

The artificial neural network 231a illustrated in FIG. 6 is one example of artificial neural networks including a plurality of hidden layers but the artificial neural network of the present disclosure is not limited thereto.

The artificial neural network 231a may be implemented by hardware, software, or a combination of hardware and software. When a part or all of the artificial neural network 231a is implemented by the software, one or more commands which configure the artificial neural network 231a may be stored in the memory 230.

The database 232 stores input data obtained from the input interface 220, learning data (or training data) used to learn a model, a learning history of the model, and so forth.

The input data stored in the database 232 may be not only data which is processed to be suitable for the model learning but also input data itself which is not processed.

The learning processor 240 is a configuration corresponding to the learning processor 130 of FIG. 4.

The learning processor 240 may train (or learn) the artificial neural network 231a using training data or a training set.

The learning processor 240 may immediately obtain data which is obtained by pre-processing input data obtained by the processor 260 through the input interface 220 to learn the artificial neural network 231a or obtain the pre-processed input data stored in the database 232 to learn the artificial neural network 231a.

Specifically, the learning processor 240 repeatedly may train the artificial neural network 231a using various learning techniques described above to determine optimized model parameters of the artificial neural network 231a.

In this specification, the artificial neural network which is trained using training data to determine parameters may be referred to as a learning model or a trained model.

Here, the trained model may infer result values even while being installed in a learning device 200 of an artificial neural net and may be transferred to and installed in another device such as a terminal 100 by a transceiver 210.

Further, when the learning model is updated, the updated learning model may be transmitted to the other device such as the terminal 100 via the transceiver 210 to be loaded.

The power supply 250 is a configuration corresponding to the power supply 190 of FIG. 4.

A redundant description for corresponding configurations will be omitted.

In addition, the learning device 200 may evaluate an artificial intelligence model 231a and may update the artificial intelligence model 231a for better performance after the evaluation and provide the updated artificial intelligence model 231a to the terminal 100. Here, the terminal 100 may perform a series of steps performed by the learning device 200 solely in a local area or together with the learning device 200 through the communication with the learning device 200. For example, the terminal 100 may update the deep neural network (DNN) 174 downloaded from the learning device 200 by allowing the deep neural network (DNN) 174 in the local area through secondary learning using the user's personal data to learn the user's personal pattern.

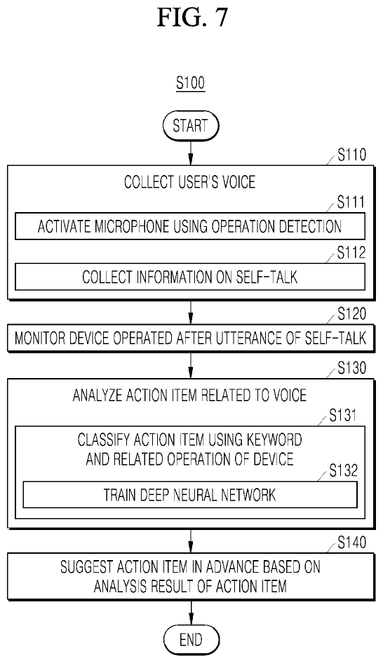

FIG. 7 is a flowchart of a method for suggesting an action item according to an embodiment of the present disclosure.

Referring to FIG. 7, a method (S100) for suggesting an action item according to an embodiment of the present disclosure includes collecting a user's voice (S110), monitoring a device operated after an utterance of a self-talk (S120), analyzing an action item related to a voice (S130), and suggesting the action item based on the analysis result of the action item (S140).

The method (S100) for suggesting an action item may be performed by the apparatus 10 for suggesting an action item that may be implemented by the terminal 100 or the smart speaker 101. The apparatus 10 for suggesting an action item may be configured to include the microphone 122 for voice collection, the memory 170 in which various application programs may be stored, and the processor 180 that controls these components. In addition, the processor 180 may control various application programs stored in the memory 170, for example, the voice collection module 171, the keyword extraction engine 172, the device monitoring module 173, the deep neural network (DNN) corresponding to the artificial intelligence model, the learning module 175 used for learning thereof, and the action item suggestion engine 176 to perform each step constituting the method (S100) for suggesting an action item.

The processor 180 may collect at least one input data from the monitoring data of the device 400 and the voice data of the user (S110).

The apparatus 10 for suggesting an action item may serve as a hub for the device 400 while it is connected to the device 400 and the network 500, for example, a local area network within a home or office. Therefore, the apparatus 10 for suggesting an action item may control the operation of the device 400 through the network 500, and collect the operation state information, that is, the monitoring data of the device 400 through the monitoring of the device 400 in operation.

The processor 180 may use the microphone 122 to collect the user's voice data. The collection of the user's voice data may include user's self-talk information which is uttered without the wake-up word.

The apparatus 10 for suggesting an action item implemented in the form of a smart speaker 101 may activate the microphone 122 using the user's motion detection even when there is no user call through the wake-up word. That is, the processor 180 may activate the microphone 122 so that the smart speaker 101 is in a listening mode only when the user's motion is detected using the sensor 140, for example, an infrared sensor (S111).

When the user's motion is detected, the processor 180 may collect the user's self-talk information uttered without the wake-up word by activating the microphone 122 (S112).

The processor 180 may monitor the device operated after the utterance of the self-talk based on the self-talk information (S120). The user's utterance of the self-talk may be present, and a specific keyword in the uttered self-talk may be related to the action item. The device related to the corresponding action item may be operated. However, there may be a case in which the self-talk, the action item, and the operation of the device are not always generated by being continuously related to each other. For example, the reason is that the device may be operated without the self-talk. In this case, the processor 180 may analyze the action item using only the monitoring data collected by monitoring the device.

The processor 180 may analyze the user's action item based on at least one input data among the user's voice data and the monitoring data of the device (S130).

For example, the processor 180 may classify the action items using the keyword included in the self-talk among the user's voices and the device operation related to the keyword (S131).

The analysis of the action item (S130) may include the analysis of the generation pattern of the classified action items.

The analysis of the action item (S130) may include the process of training the deep neural network (S132). That is, the processor 180 may train the action item suggestion model of the deep neural network to classify the user's action items based on the deep learning using the training data set including at least one of the user's self-talk, the device operated in relation to the self-talk, and the information on the operation mode and the operation time and date of the device when operated.

In the process of analyzing the action item, the action item suggestion model of the deep neural network may aggregate the number of utterances of the keyword by time zone and day of the week as shown in FIG. 1. In addition, the device operated in relation to the specific keyword by the learning training of the deep neural network and the generation pattern of the action item related thereto may be classified according to types. For example, generation patterns of action items such as an action item related to keyword ‘washing’ related to an operation of a washing machine that is generated at 6 pm on the weekend, an action item related to keyword ‘going out’ related to start-up of a vehicle that is generated immediately after the washing, and an action item related to keyword ‘boiled rice’ after a user returns from the outside that is generated on the weekend night may be grasped.

The processor 180 may suggest the action item to the user based on the analysis result of the action item (S140). As the method of suggesting an action item, the apparatus 10 for suggesting an action item may suggest the inferred action item through the voice. Such the suggestion using the voice corresponds to the active utterance by the AI agent function of the apparatus 10 for suggesting an action item operated without the wake-up word.

The suggestion S140 of the action item may be configured to include analyzing the generation requirement of the action item (S241), inferring the action item (S242), and suggesting the action item (S243).

The processor 180 may analyze the generation requirement of the action item using the action item suggestion model (S241). The processor 180 may analyze the generation requirement of the action item based on the result of the analysis process of the action item, that is, the generation pattern of the action item. The generation requirement of the action item may include whether the user's self-talk including the keyword related to the action item is uttered, whether the device related to the keyword is present, generation date, time, day, and periodicity of the action item, a user's behavior pattern, and the like.

The processor 180 may infer the generation of the action item based on the determination of the generation requirement of the action item (S242). The processor 180 may infer the generation of the action item expected at the present time by inputting information such as a user's self-talk detection, a day of the week on which the action item was executed, and the time when the action item was executed.

The processor 180 may suggest the inferred action item to the user (S243).

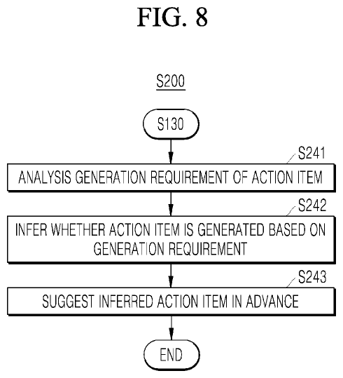

FIG. 8 is a flowchart of S140 in FIG. 7.

Referring to FIG. 8, the processor 180 may analyze the generation requirement of the action item using the action item suggestion model (S241).

The processor 180 may infer whether or not the action item is generated based on the determination of the generation requirement according to the analysis of the generation requirement (S232). Based on the generation pattern of the action item according to the analysis of the generation requirement of the action item, it may be inferred whether or not the action item is generated at the present time.

The processor 180 may suggest the inferred action item to the user through the voice (S243). Examples of the action item suggested by the apparatus 10 for suggesting an action item may include household chores related to the operation of the device 400, for example, cooking rice by an operation of an electric rice cooker, washing by an operation of a washing machine, start-up of a vehicle for going out, an operation or mode switching of an air conditioner for controlling the temperature of a room, and the like.

The processor 180 may control the operation of the device related to the action item according to the user's feedback about the suggested action item. For example, when the contents are detected by the rice cooker, the processor 180 may operate the corresponding device related to the execution of the suggested action item by transmitting a control code to the corresponding device 400 when the laundry is detected by the washing machine.

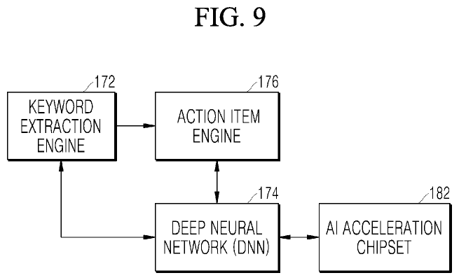

FIG. 9 is a relationship diagram of the components of the apparatus for suggesting an action item according to the embodiment of the present disclosure.

FIG. 9 shows the relationship between the components included in the apparatus 10 for suggesting an action item, that is, the relationship between the keyword extraction engine 172, the action item suggestion engine 176, the deep neural network 174, and the AI acceleration chipset 182. The processor 180 included in the apparatus 10 for suggesting an action item needs to perform a complex computation that requires a lot of time in the analysis and suggestion process of the action item. Such complex computations may include the artificial intelligence model, for example, a multi-dimensional matrix computation required in the process of shifting from each layer to a next layer in the deep neural network. The apparatus 10 for suggesting an action item may use the computational function of the server 300, but perform the speech recognition, the keyword extraction, and the analysis and suggestion of the action item based on the deep neural network using the AI acceleration chipset 182 specially manufactured for the computation of the artificial intelligence algorithms among the processor 180.

As described above, according to the present disclosure, even when there is no conversation between the users, the conversation with the user can be made through the active utterance based on the information on the self-talk.

In addition, the user may be suggested whether to perform the action item, not just the active utterance.

In addition, the generation requirement of the related action item can be inferred based on the state monitoring of the electronic device used in the home related to the action item.

Embodiments according to the present disclosure described above may be implemented in the form of computer programs that may be executed through various components on a computer, and such computer programs may be recorded in a computer-readable medium. Examples of the computer-readable media include, but are not limited to: magnetic media such as hard disks, floppy disks, and magnetic tape; optical media such as CD-ROM disks and DVD-ROM disks; magneto-optical media such as floptical disks; and hardware devices that are specially configured to store and execute program codes, such as ROM, RAM, and flash memory devices.

Meanwhile, the computer programs may be those specially designed and constructed for the purposes of the present disclosure or they may be of the kind well known and available to those skilled in the computer software arts. Examples of program code include both machine codes, such as produced by a compiler, and higher level code that may be executed by the computer using an interpreter.

The singular forms “a,” “an” and “the” in this present disclosure, in particular, claims, may be intended to include the plural forms as well. Also, it should be understood that any numerical range recited herein is intended to include all sub-ranges subsumed therein (unless expressly indicated otherwise) and accordingly, the disclosed numeral ranges include every individual value between the minimum and maximum values of the numeral ranges.

Operations constituting the method of the present disclosure may be performed in appropriate order unless explicitly described in terms of order or described to the contrary. The present disclosure is not necessarily limited to the order of operations given in the description. All examples described herein or the terms indicative thereof (“for example,” etc.) used herein are merely to describe the present disclosure in greater detail. Therefore, it should be understood that the scope of the present disclosure is not limited to the exemplary embodiments described above or by the use of such terms unless limited by the appended claims. Also, it should be apparent to those skilled in the art that various modifications, combinations, and alternations can be made depending on design conditions and factors within the scope of the appended claims or equivalents thereof.

Therefore, technical ideas of the present disclosure are not limited to the above-mentioned embodiments, and it is intended that not only the appended claims, but also all changes equivalent to claims, should be considered to fall within the scope of the present disclosure.

What is claimed is:

1. A method for suggesting an action item based on speech, the method comprising:
collecting at least one input data among monitoring data of a device and voice data of a user;
analyzing a users action item based on the at least one input data; and
suggesting the action item based on the analysis result of the action item.

2. The method of claim 1, wherein the collecting of input data includes collecting information on uttered self-talk without a wake-up word.

3. The method of claim 2, wherein the collecting of input data further includes activating a microphone using an operation detection to collect the information on the self-talk.

4. The method of claim 2, wherein the collecting of input data further includes monitoring a device operated after the utterance of the self-talk based on the information on the self-talk, and
the analyzing of an action item includes analyzing an action item related to the operation of the device.

5. The method of claim 1, wherein the analyzing of an action item includes classifying the action item using a keyword included in the self-talk among the users voices and the operation of the device related to the keyword.

6. The method of claim 5, wherein the analyzing of the action item includes analyzing a generation pattern of the classified action item.

7. The method of claim 1, wherein the analyzing of an action item includes training an action item suggestion model of a deep neural network to classify a users action item based on deep learning using a training data set including at least one of a users self-talk, a device operated in relation to the self-talk, and information on an operation mode and an operation time and date of the device when operated.

8. The method of claim 7, wherein the suggesting of an action item includes suggesting the action item in advance through the voice using the action item suggestion model.

9. The method of claim 7, wherein the suggesting of an action item includes:
analyzing a generation requirement of the action item using the action item suggestion model;
inferring the generation of the action item based on a determination of the generation requirement; and
suggesting the inferred action item in advance.

10. The method of claim 1, further comprising:
controlling the operation of the device related to the action item according to the execution of the suggested action item.

11. An apparatus for suggesting an action item based on speech, the apparatus comprising:
a microphone configured to collect a user's voice;
an action item suggestion engine configured to analyze a user's action item based on the user's voice and suggesting the action item in advance based on the analysis result of the action item; and
a processor configured to control the microphone and the action item suggestion engine.

12. The apparatus of claim 11, wherein the processor controls the microphone to collect information on uttered self-talk without a wake-up word.

13. The apparatus of claim 12, wherein the processor activates the microphone using an operation detection to collect the information on the self-talk.

14. The apparatus of claim 12, wherein the processor controls the action item suggestion engine to monitor a device operated after the utterance of the self-talk based on the information on the self-talk and analyze an action item related to the operation of the device.

15. The apparatus of claim 11, wherein the processor controls the action item suggestion engine to classify the action item using a keyword included in the self-talk among the user's voices and the operation of the device related to the keyword.

16. The apparatus of claim 15, wherein the processor controls the action item suggestion engine to analyze a generation pattern of the classified action item.

17. The apparatus of claim 11, wherein the action item suggestion engine includes a deep neural network classifying a user's action item based on deep learning, and the processor trains an action item suggestion model of the deep neural network using a training data set including at least one of a user's self-talk, a device operated in relation to the self-talk, and information on an operation mode and an operation time and date of the device when operated.

18. The apparatus of claim 17, wherein the processor suggests the action item in advance through the voice using the action item suggestion model.

19. The apparatus of claim 17, wherein the processor analyzes a generation requirement of the action item using the action item suggestion model and suggests an inferred action item in advance based on a determination of the generation requirement.

20. The apparatus of claim 11, wherein the processor controls the operation of the device related to the action item according to the execution of the suggested action item.
